(19) United States
(12) Patent Application Publication
(10) Pub. No.: US 2011/0030222 A1
(43) Pub. Date: Feb. 10, 2011

(54) Cakeboard with string cake cutter

(76) Inventors: Charles Qumeng Chen, Havertown, PA (US); Jun Chen, Havertown, PA (US)

Correspondence Address: Charles Chen, 33 Jacalyn Drive, Havertown, PA, 19083, US

(21) Appl. No.: 12/462,478

(22) Filed: Aug. 5, 2009

(51) Int. Cl. A21C 15/04; B26B 11/00

(52) U.S. Cl. 30/114; 30/124

(57) ABSTRACT

The present invention relates to cake cutters that may cut a cake thoroughly different from any cake-cutting device on the market or previously claimed. The invention is a modified corrugated cardboard circle or square, commonly known as a cakeboard. There are two iterations of said invention, one that is designed to cut a circular cake into slices, and another one to cut a rectangular cake into rectangular or square pieces. Both iterations involve using string to cut the cake, as opposed to a knife, and both are disposable and can be built into the cakeboard itself. The circular cake cutter is made with a center pivoting ring with a string strung through the center, designed to cut the cake into slices. The rectangular iteration involves dowels with strings that can be cut off depending on personal preference of the size of the piece of cake.

### REFERENCES

| | | | |
|---|---|---|---|
| 6,381,851 | Combination cutter | Debbie Jean Meyer | May 4, 1905 |
| | and server | | |
| 1,948,592 | Cake knife | William L. Nelson | Jun. 1, 1933 |
| 2,403,190 | Cake cutter | A. J. Parraga | Oct. 18, 1944 |
| 4,213,241 | Cake layer cutter | Ray E. Haapala | Mar. 30, 1979 |
| 4,411,066 | Cake cutter | Edward Allahverdian | Oct. 25, 1983 |
| D363860 | Cake cutter | John F. Gallo | Nov. 7, 1995 |

### BACKGROUND

This invention stems from the need to cut a cake cleanly, conveniently, and safely without a knife. Cutting cake with a knife leaves behind a trail of frosting and cake bits, regardless of the special design of the knife for this purpose. The inspiration for this invention was found in the string wound around mailing envelopes, as well as the dispenser for dental floss.

The invention eliminates the mess that is created with a cake knife. It is also convenient, cheap to manufacture, easy to use, disposable. It can be packaged within the cakebox on the cakeboard wherever cakes are sold. It is an improvement in convenience, safety as well as cleanliness over a standard cake cutter knife.

### SUMMARY OF INVENTION

This invention is comprised of cakeboards with string cake cutters for different shapes of the cakes, one is a string attached to a button at the center of a circular cakeboard to cut the round cake, and the other is several strings attached to dowels on the length and width of a rectangular cakeboard to cut the square cake.

This invention relates to an improved cake cutter that are comprised of string(s) and dowels attached to cakeboards. There are several advantages of using these types of cutter over a few previous inventions indicated in references: 1). Convenience: the cutter is already included in the product, thus eliminates the inconvenience caused by the need to use extra tool; 2). Safety: this invention avoids using a knife, thus eliminates the potential danger associated with it; 3) Low cost: the this invention uses strings, dowels, and button, all of which are cost effective for both manufacturers and consumers; 4).Speed: using strings to cut cake is faster than using a knife, especially for the rectangular cake; 5). Neatness: cutting cakes using strings avoid the mess of using knife, and the disposability of the invented product eliminates the need to clean the knife and utensils.

### BRIEF DESCRIPTION OF DRAWINGS

This invention is comprised of two types of cutters: 1) a string attached to the center of a circular cakeboard to cut the round cake, and 2) strings attached to dowels on the length and width of a rectangular cakeboard to cut the square cake. There are total of 6 Figures.

FIG. 1 is a side/frontal view of a round cakeboard (1) with cake, with a button (2) at the center of the cakeboard, a string (3) attached to both the button and a plastic ring (4), which is for easy grabbing.

FIG. 2 is a top view of the cakeboard (1) with the button in the center (2), a string (3) attached on one end to a plastic ring (4), and markings (5) at the edge of the cakeboard are used to guide the cuts.

FIG. 3 is a perspective view of the cakeboard (1) with cake. The string (2) is ready to make the first cut through the cake. The string is going to be dragged to the other end of the cake, and make the first cut through the other side of the cake. Arrow shows the direction for the string to move.

FIG. 4 describes a rectangular cakeboard (6) with strings (7) that are attached to two dowels on the rectangular cakeboard. One is on length (8) and the other is on width (9). Dowels 8 and 9 are attached to the cakeboard. The other two mirroring dowels, 10 and 11, are rolled with one end of the strings and put on the edges of the cakeboard (6), and are attached to the other end of the strings (but not attached to the cakeboard), which will be used to move the strings to cut the cake into square pieces. This figure shows the positions of four dowels when cake is in the cakebox. The number of strings is dependent on the size of the cake.

FIG. 5 describes the two mirror dowels, 10 and 11, rolled out and ready to cut the rectangular cake into square pieces.

FIG. 6 is a perspective view of the dowels 10 and 11. The dowels are making the cut across the cake. Arrows show the directions for the dowels to cut through the cake. There is an instructional printing on the board, which tells the user to move dowel 10 first and then move dowel 11 when cutting the cake.

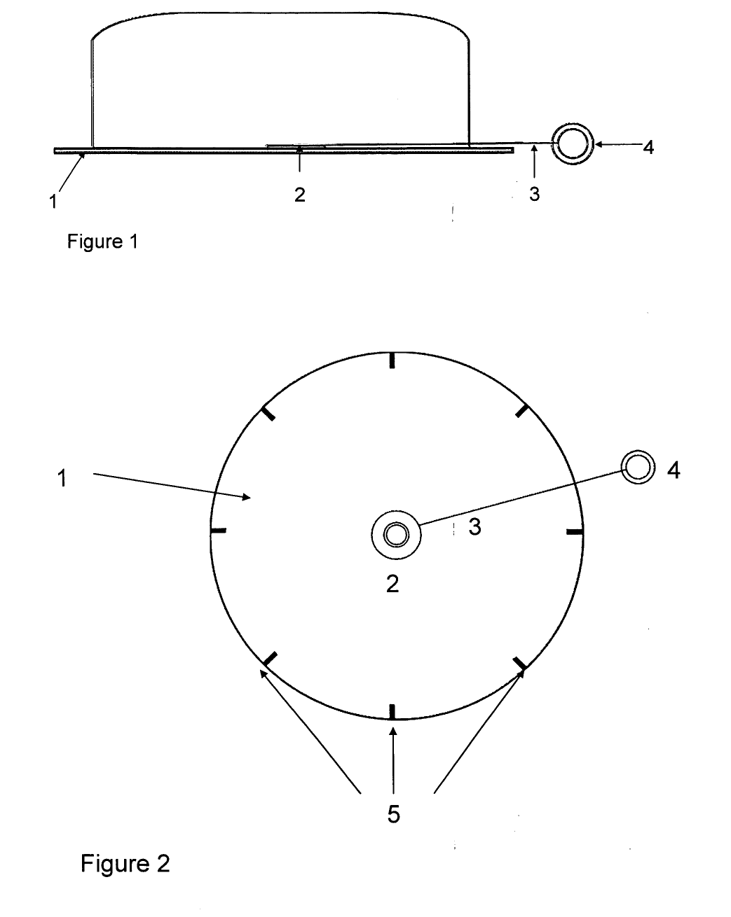

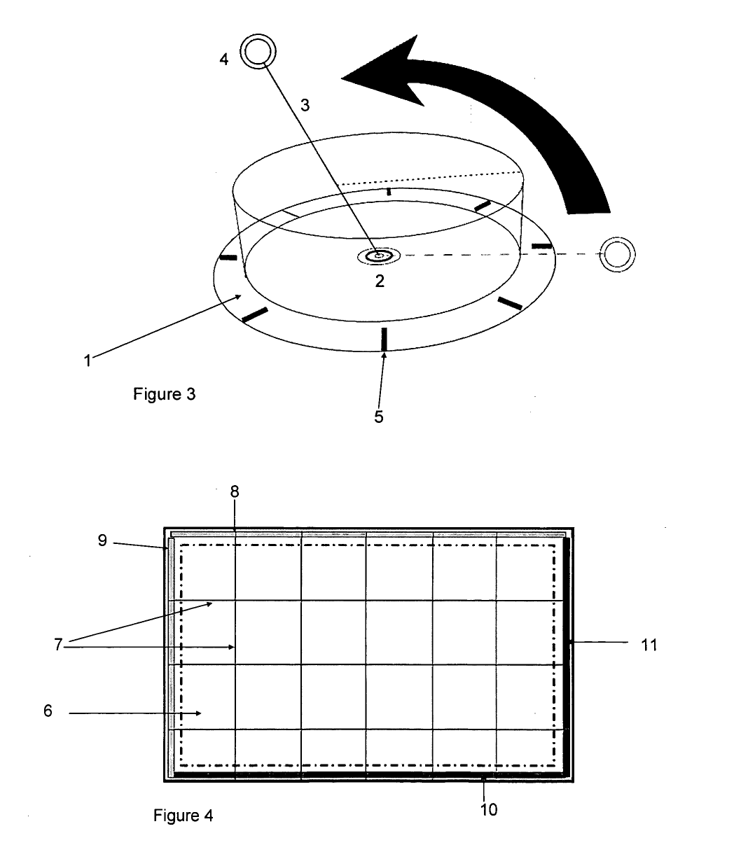

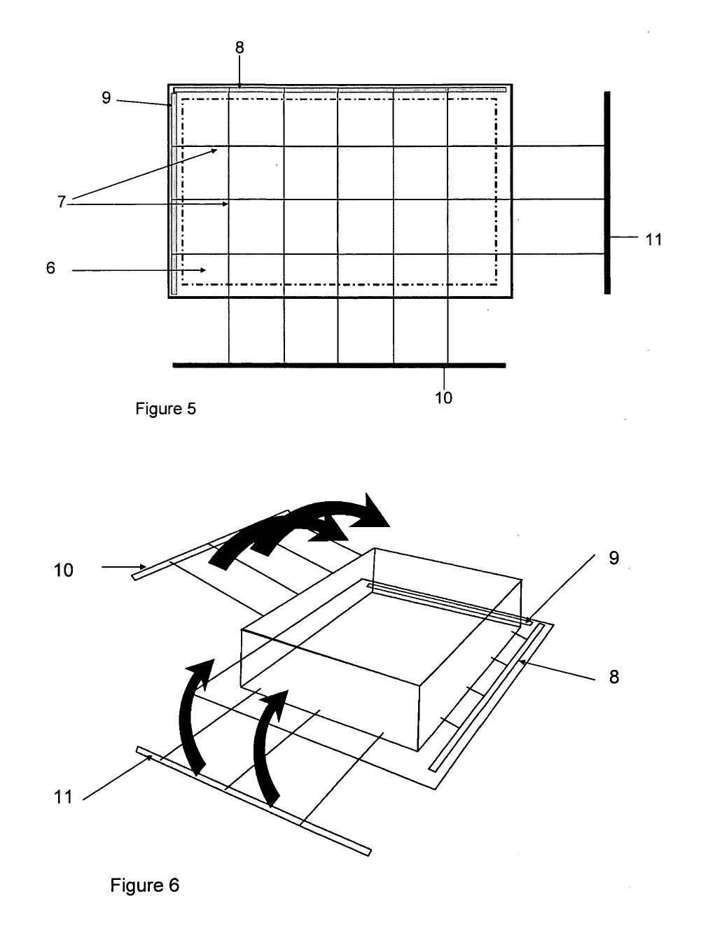

### DETAILED DESCRIPTION OF INVENTION

The invention relates to the use of string(s) that are attached to a cakeboard (circular or rectangular) using rings or dowels, which can be used to cut cake into pieces without using conventional tools, such as knives. For the circular cakeboard, the invention comprises of such parts as a standard cakeboard with markings around the edges that divide the cakeboard, graphically, into eighths or any number as desired, a button with a small hole drilled into the center of the cakeboard, and a piece of string strung through the button in the center with a plastic ring tied to the end of the string strung out of the top of the cakeboard. The length of the string above the cakeboard is four inches longer than the radius of the cakeboard. For the rectangular cakeboard, the invention is a modified piece of rectangular cakeboard, with four dowels on each of the four edges of the rectangular cakeboard. One horizontal dowel and one vertical dowel are stapled into the cakeboard, while the other two are free to be moved by hand. Strings run horizontally across the cakeboard, tied from dowel to dowel, as well as vertically down the cakeboard, also tied from dowel to dowel. The strings are oriented so that all of the vertical strings are below the horizontal strings. The positions of the strings on either side of the cakeboard are adjustable, so as to change the size of each individual cut piece.

What is claimed is:

1. A cakeboard of variable shape, designed to cut cake with a built-in string cutter as outlined in claims 2 to 8, and variations thereof.

2. A cakeboard with
a. a string cake cutter that is attached to a circular cakeboard;
b. a button in the center of the cakeboard;
c. a plastic ring attached to the other end of the string.

3. A circular cakeboard with
a. a string cutter as described in claim 2;
b. a hole drilled through the center of the cakeboard for attaching the string, here the hole is called button.

4. A circular cakeboard with a string cake cutter that has variable length strung through hole mentioned in claim 2, whose purpose is to cut the cake.

5. A circular cakeboard with a string cake cutter with a plastic ring tied to the other end of the string mentioned in claim 3 for easy grab when cut the cake, positioned on the side of the cakeboard.

6. A modified rectangular cakeboard with dowels and strings attached to cakeboard to cut the rectangular cake.

7. A modified rectangular cakeboard with two dowels attached to one length and one width of the cakeboard, and also attached to one end of strings, and two dowels that mirror the dowels described in claim 5, and attached to the other end of the strings, but free from attaching to the cakeboard.

8. A modified rectangular cakeboard with strings running along the length and width of the rectangular cakeboard attached to the dowels described in claim 7, to cut the rectangular cake into squares.
